(19) United States
(12) Patent Application Publication
(10) Pub. No.: US 2011/0087655 A1
(43) Pub. Date: Apr. 14, 2011

(54) Search Ranking for Time-Sensitive Queries by Feedback Control

(75) Inventors: Ruiqiang Zhang, Cupertino, CA (US); Yi Chang, Santa Clara, CA (US); Anlei Dong, Fremont, CA (US); Zhaohui Zheng, Mountain View, CA (US)

(73) Assignee: YAHOO! INC., Sunnyvale, CA (US)

(21) Appl. No.: 12/576,534

(22) Filed: Oct. 9, 2009

(51) Int. Cl. G06F 17/30

(52) U.S. Cl. 707/725; 707/E17.014

(57) ABSTRACT

In one embodiment, a method comprises accessing a search query received at a search engine; identifying a plurality of network resources for the search query; calculating a ranking score for each of the network resources; determining whether the search query is year-qualified; and if the search query is year-qualified, then adjusting the ranking scores of selected ones of the network resources based on a difference between the ranking score of an oldest one of the network resources and the ranking score of a newest one of the network resources and a confidence score representing a likelihood that the search query is year-qualified.

### TECHNICAL FIELD

The present disclosure generally relates to improving the quality of the search results generated by the search engines and more specifically relates to improving the ranking of the search results generated for time-sensitive search queries by search engines.

### BACKGROUND

The Internet provides a vast amount of information. The individual pieces of information are often referred to as “network resources” or “network contents” and may have various formats, such as, for example and without limitation, texts, audios, videos, images, web pages, documents, executables, etc. The network resources or contents are stored at many different sites, such as on computers and servers, in databases, etc., around the world. These different sites are communicatively linked to the Internet through various network infrastructures. Any person may access the publicly available network resources or contents via a suitable network device (e.g., a computer) connected to the Internet.

However, due to the sheer amount of information available on the Internet, it is impractical as well as impossible for a person (e.g., a network user) to manually search throughout the Internet for specific pieces of information. Instead, most people rely on different types of computer-implemented tools to help them locate the desired network resources or contents. One of the most commonly and widely used computer-implemented tools is a search engine, such as the search engines provided by Yahoo!® Inc. (http://search.yahoo.com) and Google™ Inc. (http://www.google.com). To search for information relating to a specific subject matter on the Internet, a network user typically provides a short phrase or a few keywords describing the subject matter, often referred to as a “search query” or simply “query”, to a search engine. The search engine conducts a search based on the search query using various search algorithms and generates a search result that identifies network resources or contents that are most likely to be related to the search query. The network resources or contents are presented to the network user, often in the form of a list of links, each link being associated with a different network document (e.g., a web page) that contains some of the identified network resources or contents. In particular embodiments, each link is in the form of a Uniform Resource Locator (URL) that specifies where the corresponding document is located and the mechanism for retrieving it. The network user is then able to click on the URL links to view the specific network resources or contents contained in the corresponding document as he wishes.

Sophisticated search engines implement many other functionalities in addition to merely identifying the network resources or contents as a part of the search process. For example, a search engine usually ranks the identified network resources or contents according to their relative degrees of relevance with respect to the search query, such that the network resources or contents that are relatively more relevant to the search query are ranked higher and consequently are presented to the network user before the network resources or contents that are relatively less relevant to the search query. The search engine may also provide a short summary of each of the identified network resources or contents.

There are continuous efforts to improve the qualities of the search results generated by the search engines. Accuracy, completeness, presentation order, and speed are but a few of the performance aspects of the search engines for improvement.

### SUMMARY

The present disclosure generally relates to improving the quality of the search results generated by the search engines and more specifically relates to improving the ranking of the search results generated for the time-sensitive search queries by the search engines.

Particular embodiments access a search query received at a search engine; identify a plurality of network resources for the search query; calculate a ranking score for each of the network resources; determine whether the search query is year-qualified; and if the search query is year-qualified, then adjust the ranking scores of selected ones of the network resources based on a difference between the ranking score of an oldest one of the network resources and the ranking score of a newest one of the network resources and a confidence score representing a likelihood that the search query is year-qualified.

These and other features, aspects, and advantages of the disclosure are described in more detail below in the detailed description and in conjunction with the following figures.

### BRIEF DESCRIPTION OF THE DRAWINGS

FIG. 1 (PRIOR ART) illustrates an example search result.

FIG. 2 illustrates an example method for improving the ranking of the search results generated for the year-qualified search queries.

FIG. 3 illustrates an example network environment.

FIG. 4 illustrates an example computer system.

### DETAILED DESCRIPTION

The present disclosure is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

A search engine is a computer-implemented tool designed to search for information relevant to specific subject matters or topics on a network, such as the Internet, the World Wide Web, or an Intranet. To conduct a search, a network user may issue a search query to the search engine. The search query generally contains one or more words that describe a subject matter. In response, the search engine may identify one or more network resources that are likely to be related to the search query, which may collectively be referred to as a “search result” identified for the search query. The network resources may be any format including, without limitation, image, video, audio, text, executable, etc. The network resources are usually ranked and presented to the network user according to their relative degrees of relevance to the search query.

Sophisticated search engines implement many other functionalities in addition to merely identifying the network resources as a part of the search process. For example, a search engine usually ranks the network resources identified for a search query according to their relative degrees of relevance with respect to the search query, such that the network resources that are relatively more relevant to the search query are ranked higher and consequently are presented to the network user before the network resources that are relatively less relevant to the search query. The search engine may also provide a short summary of each of the identified network resources.

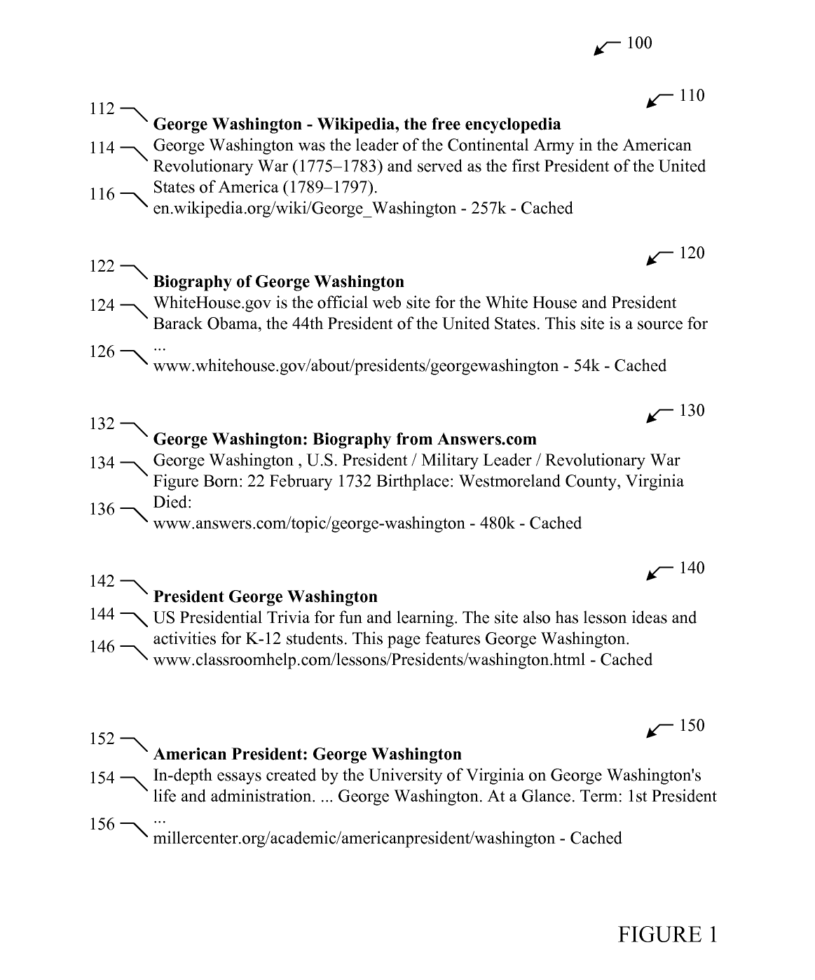

FIG. 1 (PRIOR ART) illustrates an example search result 100 that identifies five network resources and more specifically, five web pages 110, 120, 130, 140, 150. Search result 100 is generated in response to an example search query “President George Washington”. Note that only five network resources are illustrated in order to simplify the discussion. In practice, a search result may identify hundreds, thousands, or even millions of network resources. Network resources 110, 120, 130, 140, 150 each includes a title 112, 122, 132, 142, 152, a short summary 114, 124, 134, 144, 154 that briefly describes the respective network resource, and a clickable link 116, 126, 136, 146, 156 in the form of a URL. For example, network resource 110 is a web page provided by WIKIPEDIA that contains information concerning George Washington. The URL of this particular web page is “en.wikipedia.org/wiki/George_Washington”.

Network resources 110, 120, 130, 140, 150 are presented according to their relative degrees of relevance to search query “President George Washington”. That is, network resource 110 is considered somewhat more relevant to search query “President George Washington” than network resource 120, which is in turn considered somewhat more relevant than network resource 130, and so on. Consequently, network resource 110 is presented first (i.e., at the top of search result 100) followed by network resource 120, network resource 130, and so on. To view any of network resource 110, 120, 130, 140, 150, the network user requesting the search may click on the individual URLs of the specific web pages.

In particular embodiments, the ranking of the network resources with respect to the search queries may be determined by a ranking algorithm or a ranking model implemented by the search engine. Within the context of the present disclosure, the two terms, “ranking algorithm” and “ranking model”, refer to the same concept and are used interchangeably. Given a search query and a set of network resources identified in response to the search query, the ranking algorithm ranks the network resources in the network-resource set according to their relative degrees of relevance with respect to the search query. More specifically, in particular embodiments, the network resources that are relatively more relevant to the search query are ranked higher than the network resources that are relatively less relevant to the search query, as illustrated, for example, in FIG. 1.

In particular embodiments, as a part of the ranking process, the ranking algorithm may determine a ranking score for each of the network resources identified for a search query. For example, the network resources that are relatively more relevant to the search query may receive relatively higher ranking scores than the network resources that are relatively less relevant to the search query. The network resources may then be ranked according to their respective ranking scores.

In particular embodiments, a ranking algorithm implemented by a search engine may be trained using machine learning. Briefly, machine learning is a scientific discipline that is concerned with the design and development of algorithms that allow computers to learn based on data. The desired goal is to improve the algorithms through experience (e.g., by applying the data to the algorithms in order to “train” the algorithms). The data are thus often referred to as “training data”. More specifically, machine learning is the process of training computers to learn to perform certain functionalities. Typically, an algorithm is designed and trained by applying training data to the algorithm. The algorithm is adjusted (i.e., improved) based on how it responds to the training data. Often, multiple sets of training data may be applied to the same algorithm so that the algorithm may be repeatedly improved.

One type of algorithm of machine learning is transduction, also known as transductive inference. Typically, such an algorithm may predict an output in response to an input. To train such an algorithm, for example, the training data may include training inputs and training outputs. The training outputs may be the desirable or correct outputs that should be predicted by the algorithm. By comparing the outputs predicted by the algorithm in response to the training inputs with the training outputs, the algorithm may be appropriately improved so that, in response to the training inputs, the algorithm predicts outputs that are the same as or similar to the training outputs. In particular embodiments, the type of training inputs and training outputs in the training data may be similar to the type of actual inputs and actual outputs to which the algorithm is to be applied.

A ranking algorithm may be one application for the transduction type of machine learning. Typically, the training data may include one or more sets of feature vectors extracted from search queries and network resources identified for the search queries. The goal of machine learning the ranking algorithm is to find the parameter setting that optimizes some relevance metrics given the editor-judged training data.

While the currently existing machine-learned ranking algorithms may improve average relevance, they may be ineffective for certain special cases. Specifically, time-sensitive search queries, or simply time-sensitive queries, may be one such special case that the currently existing machine-learned ranking algorithms may have a hard time providing optimal ranking results due to the limited training data as the currently existing ranking algorithms are typically trained based on anchor text features, hyperlink induced features, and click-through rate features. These types of features tend to favor older network resources more than newer ones because the older network resources have exited longer and therefore have more links and clicks than the newer network resources.

In particular embodiments, a time-sensitive query may be a search query that has a connection with time, and more specifically, may be especially relevant to a specific time period. For example, a search query relating to a news event may be especially relevant to the time period during which the event occurs, and thus may be considered as a time-sensitive query with respect to that time period. Empirical data indicate that, in practice, time-sensitive queries amounts to approximately 15% of the total query volume in the query logs maintained by the search engines.

Time-sensitive queries may be grouped into different categories. One category may be “recurrent-event queries”. A recurrent-event query typically describes a periodic event such as, for example, conference names, (e.g., “naacl”, “sigir”, “icml”), product reviews (e.g., “ipod review”, “Honda accord review”), sports games (e.g., “NFL”, “FIFA”, “NBA”, “MLB draft”), etc. Another category may be “newsworthy queries”. A newsworthy query may describe a news event or may trigger related news articles or stories, such as queries relating to celebrities, natural disaster, or breaking news.

Time may be an important dimension of relevance when ranking the network resources as a part of the search process, since search engine users tend to prefer more recent network resources to older network resources. This may be especially true for those network resources identified for or corresponding to the time-sensitive queries. Consequently, when ranking the network resources identified for a time-sensitive query, it is reasonable to rank the more recent, newer network resources higher than the older network resources. For example, consider the example query “naacl” (referring to a conference held by the North American Chapter of the Association for Computational Linguistics), which is a recurrent-event query. The following TABLE 1 shows two example search results, Search Result 1 and Search Result 2, generated for query “naacl”. The ranking order for Search Result 1 may be considered better than that of Search Result 2 because the most recent network resource associated with the recent event, “naacl 2009”, is ranked higher than other years with Search Result 1.

TABLE 1
Two Example Search Results for an
Example Recurrent-Event Query

| Search Result 1 | Search Result 2 |
|---|---|
| A: naacl.org (16.0) | A: naacl.org (16.0) |
| B: naacl2009.org (15.0) | D: naacl2006.org (13.0) |
| C: naacl2009.org/workshops | E: naacl2001.org (12.0) |
| (14.0) | B: naacl2009.org (11.0) |
| D: naacl2006.org (13.0) | C: naacl2009.org/workshops |
| E: naacl2001.org (12.0) | (10.0) |

To improve the ranking orders determined by the currently existing ranking algorithms for the network resources identified for the time-sensitive queries so that the newer network resources may be ranked higher than the older network resources for the time-sensitive queries, particular embodiments may adjust the ranking orders determined by the currently existing ranking algorithms when the ranking is performed for the time-sensitive queries. Given a time-sensitive query and a set of network resources identified for the time-sensitive query, particular embodiments may first compute a ranking score for each of the network resources using a suitable ranking algorithm, and then adjust the ranking scores of some of the network resources base on the ranking score computed for the oldest one of the network resources and the ranking score computed for the newest one of the network resources in the network-resource set.

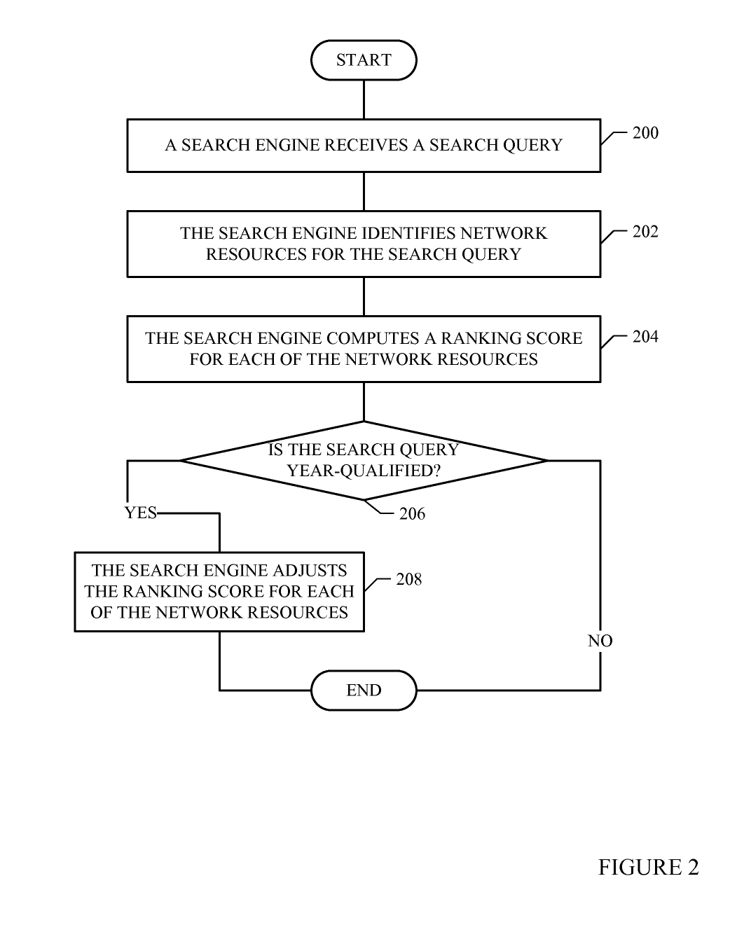

FIG. 2 illustrates an example method for improving the ranking of the search results generated for the time-sensitive search queries. For the purpose of clarification, hereafter, let q denote a generic search query (i.e., a search query that may or may not be time sensitive); let q^{t} denote a time-sensitive search query; let r denote a generic network resource; and let [symbol] ={r₁, r₂, . . . , rₙ} denote a set of n network resources identified for search query q.

In particular embodiments, when a search engine receives a search query, q, as illustrated in step 200 (e.g., when a search engine user issues search query q to the search engine), the search engine may identify a set of network resources, [symbol] , for search query q, as illustrated in step 202. The search engine may implement any suitable search algorithm (e.g., crawler, inverted indexing, etc.) to identify network-resource set [symbol] The search engine may compute a ranking score for each of the network resources, rᵢ, in network-resource set [symbol] using any suitable ranking algorithm (e.g., a currently existing machine-learned ranking algorithm implemented by the search engine), as illustrated in step 204. Hereafter, let R(q, rᵢ) denote the ranking score calculated for a particular network resource, rᵢ where rᵢ ε [symbol] , with respect to search query q using a suitable ranking algorithm. R(q, rᵢ) may be considered a “base ranking score” for network resource rᵢ because the time-sensitivity aspect of search query q is not necessarily taken into consideration during the calculation of R(q, rᵢ) by the currently existing ranking algorithm.

In particular embodiments, the search engine may determine whether search query q is a time-sensitive query (i.e., q^{t}), as illustrated in step 206. To do so, particular embodiments may consider a special class of time-sensitive queries called “year-qualified queries” (YQQs), hereafter denoted as q^{YQ}. Particular embodiments may consider two types of year-qualified queries: explicit YQQs and implicit YQQs. In particular embodiments, an explicit YQQ is a search query that has a year included in it, such as, for example, “naacl 2009”, “beijing 2008 olympic”, or “2010 fifa world cup”. In contrast, an implicit YQQ is a search query that does not necessarily have a year attached to it but nevertheless may describe a subject matter in connection with a specific year. Empirical data indicate that, in practice, approximately 10% of the total query volume in the query logs maintained by the search engines are year-qualified queries.

To identify an explicit YQQ is relatively straightforward. Particular embodiments may parse a search query to determine whether any of the words in the search query is a four-digit year. If there is a four-digit year included in the search query, then particular embodiments may consider the search query as an explicit YQQ.

Sometimes, a search query may include a four-digit number that does not really refer to a year. For example, a search query describing a street address (e.g., “2006 main st”) may have a four-digit number, but this number actually refers to an address, not a year. However, because such cases are sufficiently rare in practice, particular embodiments may ignore such distinctions and consider any and all search queries that include four-digit numbers as explicit YQQs. Alternatively, particular embodiments may place constraints on the four-digit numbers found in the search queries that may be considered as four-digit years. For example, a year-range constraint may specify that only four-digit numbers between 2001 to 2019 may be interpreted as years if they are included in the search queries. Four-digit numbers outside of this range may be treated as regular numbers, not years. Thus, four-digit numbers such as 5321, 4726, or 1852 are not interpreted as years.

To identify an implicit YQQ is slightly more complicated. Particular embodiments may construct a dictionary of the year-qualified queries (YQQ dictionary). To do so, particular embodiments may examine one or more query logs maintained by one or more search engines. These query logs typically are used to record the search queries issued to and received at the search engines. Particular embodiments may extract all the explicit YQQs (i.e., those search queries that include the four-digit years) from the query logs, and then remove the four-digit years from the explicit YQQs. The resulting queries (i.e., the explicit YQQs with the four-digit years removed) may form the dictionary of the year-qualified queries. Thus, the implicit YQQs may in effect be obtained from the explicit YQQs. Particular embodiments may save the YQQ dictionary. In particular embodiments, the YQQ dictionary may be constructed offline (i.e., pre-constructed).

To determine whether a search query is an implicit YQQ, particular embodiments may compare the search query against the search queries included in a YQQ dictionary. If a match is found, then particular embodiments may consider the search query as an implicit YQQ.

Empirical data suggest that the search queries included in a YQQ dictionary that are obtained from the query logs may be grouped into three categories: recurrent-event queries (e.g.,“naacl”, “us open tennis”), newsworthy queries (e.g., “steve ballmer”, “china foreign reserves”), and others (e.g., “christmas”, “youtube”). It is possible that the method described in the present disclosure may produce better results (i.e., more effective results) for one category of year-qualified queries than another category. However, on average, the method may improve the ranking for all types of year-qualified queries.

If search query q is a year-qualified query as either an explicit YQQ or an implicit YQQ (i.e., search query q is in fact year-qualified query q^{YQ}; step 206, “YES”), then particular embodiments may adjust the base ranking scores, R(q, r), calculated for some of the network resources so that the newer network resources in network-resource set R^{q} are ranked higher than the older network resources in network-resource set R^{q}. In particular embodiments, the ranking score adjustment may be determined based on the ranking error made by the ranking algorithm used to calculate the base ranking scores as described in connection with step 204. If F(q, rᵢ) denotes the adjusted ranking score, or the final ranking score, for network resource rᵢ with respect to search query q, then in particular embodiments, F(q, rᵢ) may be calculated as:

$$F ( \begin{matrix}q , & {r}_{i}\end{matrix} ) = \{ \begin{matrix}R ( \begin{matrix}q , & {r}_{i}\end{matrix} ) ; & q ∉ YQQ \\ R ( \begin{matrix}q , & {r}_{i}\end{matrix} ) + Q ( \begin{matrix}q , & r\end{matrix} ) ; & q ∈ YQQ .\end{matrix} \qquad ( 1 )$$

Thus, in particular embodiments, no ranking-score adjustment is made to the base ranking scores (i.e., F(q, rᵢ)=R(q, rᵢ)) if search query q is not a year-qualified query (step 206, “NO”).

In the EQUATION (1), Q(q, r) represents the adjustment made to the base ranking score for a network resource. Particular embodiments may determine Q(q, r) based on the ranking error made by the ranking algorithm used to calculate the base ranking scores as described in connection with step 204.

Among all the network resources in network-resource set [symbol] one of the network resources may be considered the oldest network resource, hereafter denoted as rₒ, and one of the network resources may be considered the newest network resource, hereafter denoted as rₙ. To identify the oldest and the newest network resource in network-resource set [symbol] particular embodiments may need to determine the age of each of the network resources in network-resource set [symbol] To do so, particular embodiments may determine a timestamp for each for each of the network resources, rᵢ. In particular embodiments, the timestamp of network resource rᵢ, hereafter denoted by yᵢ=Y(rᵢ), may include at least a year and optionally a month, a day, an hour, a minute, and a second. Thus, the timestamp of the oldest network resource rₒ is denoted as yₒ=Y(rₒ); and the timestamp of the newest network resource rₒ is denoted as yₙ=Y(rₙ). In addition, the base ranking score for the oldest network resource rₙ is R(q, rₒ); and the base ranking score for the newest network resource rₙ is R(q, rₙ). In particular embodiments, the year of the timestamp, yᵢ, may indicate the year that the event described by the content of network resource rᵢ has occurred or will occur.

The timestamp of a network resource may be determined from various information sources. In some cases, the timestamp of a network resource may be determined from the tile, the URL, the anchor text, or the content of the network resource. For example, from the URL of a web page, “www.naacl2009.org”, the timestamp year 2009 may be determined. In some cases, the timestamp of a network resource may be determined based on the discovery time or the link time of the network resource. In some cases, the timestamp of a network resource may be determined based on some machine generated dates.

Particular embodiments may determine the oldest network resource rₒ and the newest network resource rₙ in network-resource set [symbol] based on the timestamps determined for the individual network resources. In particular embodiments, Q(q, r) may then be calculated as:

$$Q ( \begin{matrix}q , & r\end{matrix} ) = \{ \begin{matrix}( e ( \begin{matrix}{r}_{o} , & {r}_{n}\end{matrix} ) + k ) {e}^{λα ( q )} ; & {y}_{i} = {y}_{n} \\ 0 ; & {y}_{i} \neq {y}_{n} .\end{matrix} \qquad ( 2 )$$

Note that according to EQUATION (2), ranking-score adjustment is only applied to the base ranking scores of those network resources having the same year timestamp as that of the newest network resource rₙ (i.e., yₙ). The base ranking scores of those network resources older in years than the newest network resource rₙ are in fact not adjusted. In addition, the same amount of ranking-score adjustment is applied to all the base ranking scores of those network resources having the same year timestamp as that of the newest network resource rₙ within a particular network-resource set.

In EQUATION (2), e(rₒ, rₙ) signifies the ranking error made by the ranking algorithm used to calculate the base ranking scores if the newest network resource rₙ is ranked lower than the oldest network resource rₒ. In particular embodiments, assuming a higher-ranked network resource receives a higher ranking score, e(rₒ, rₙ) may be defined as:

e(rₒ, rₙ)=R(q, rₒ)−R(q, rₙ). (3)

Note that in particular embodiments, the adjustment to the base ranking scores is made only when the oldest network resource has a higher base ranking score than the newest network resource. The goal of the adjustment is to increase the final ranking scores of the newer network resources by adding an amount relating to the difference between the base ranking score of the oldest network resource and the base ranking score of the newest network resource to the base ranking scores of the newer network resources. Therefore, if the newest network resource already has a higher base ranking score than the oldest network resource, then there is no need for further adjustment.

Sometimes, it is possible that multiple network resources in network-resource set R^{q} may have the same timestamp, especially when the timestamps of the network resources only include a year number or a year and a month. Consequently, it is possible that multiple network resources in network-resource set R^{q} may be considered as “the oldest” or “the newest” network resource in network-resource set [symbol] When choosing an oldest and a newest network resource from network-resource set [symbol] to use their respective base ranking scores to calculate e(rₒ, rₙ) according to EQUATION (3), if there are multiple oldest or newest network resources in network-resource set [symbol] particular embodiments may choose the oldest or the newest network resource that has the highest or the lowest base ranking score. In other words, if there are multiple oldest or newest network resources in network-resource set [symbol] particular embodiments may use the highest-ranked oldest or newest network resource according to its base ranking score to calculate e(rₒ, rₙ).

In EQUATION (2), k is a small shift value (e.g., a constant) for direction control. When k<0, the newest network resource is adjusted slightly under the oldest network resource. Otherwise, when k≧0, the newest network resource is adjusted slightly over the oldest one. In particular embodiments, the actual value of k may be determined based on experiments (e.g., while training the ranking model), and experiments suggest that k>0 may give better results. More specifically, experiments suggest that different k values may have significant impact on the performance of the ranking-score adjustment and that k=0.3 may provide satisfactory results.

In EQUATION (2), α(q) represents the confidence score of search query q being a year-qualified query (i.e., the likelihood that search query q is really a year-qualified query, q^{YQ}). In particular embodiments, the confidence score is greater for a search query if the search query is more likely to be a year-qualified query. As described above in connection with step 206, empirical data suggest that the year-qualified queries may be grouped into three categories: recurrent-event queries, newsworthy queries, and others. Particular embodiments may use the confidence score to distinguish the three categories of year-qualified queries and their adjustments to the base ranking scores. To do so, particular embodiments may define the confidence score of search query q as:

$$α ( q ) = \frac{{\sum }_{y} w ( \begin{matrix}q , & y\end{matrix} )}{\# ( q ) + {\sum }_{y} w ( \begin{matrix}q , & y\end{matrix} )} ; \qquad ( 4 )$$

where: (1) w(q, y)=#(q.y)+#(y.q) with #(q.y) denoting the number of times that search query q is post-qualified with the year y in the query logs and #(y.q) denoting the number of times that search query q is pre-qualified with the year y in the query logs; and (2) #(q) is the counts of the independent queries, without associating with any other terms, in the query logs. Note that the weight w(q, y) measures how likely search query q is to be qualified with year y, which forms the basis of the mining and analysis on the year-qualified queries. In particular embodiments, a search query pre-qualified with a year is a search query having a four-digit year at the beginning of the search query (e.g., “2009 naacl”). A search query post-qualified with a year is a search query having a four-digit year at the end of the search query (e.g., “naacl 2009”). If a search query does not include a four-digit year anywhere, particular embodiments may consider it as an independent search query (e.g., “naacl”).

In EQUATION (2), λ is a weighting parameter for adjusting α(q). In particular embodiments, the actual value of λ may be determined based on experiments. Experiments suggest that a higher λ value may hurt the performance of the ranking-score adjustment and that λ=0.4 may provide satisfactory results. In practice, λ may be used to control the confidence score α(q). For example, λ=0 in effect turns off the confidence score, according to EQUATION (2). However, experiments suggest that turning off the confidence score may result in lower performance of the ranking-score adjustment. Thus, α(q) may be an important parameter in EQUATION (2).

In particular embodiments, the exponential function e^{λα(q)} is a weighting to control boosting value. A higher value, for example as with a higher confidence score α(q), may provide a larger boosting value for Q(q, r).

In particular embodiments, the adjustment to the base ranking scores for the network resources corresponding to a year-qualified query is based on the feedback control theory. The ideal input is R(q, rₒ) representing the desired ranking score for the newest network resource, R(q, rₙ). But sometimes, the real ranking score calculated by a ranking algorithm implemented by a search engine is R(q, rₙ). Because a search engine is a dynamic system, its ranking is changing over time, which may result in ranking errors, e(rₒ, rₙ)=R(q, rₒ)−R(q, rₙ). In particular embodiments, the goal is to design a function that adjusts the ranking orders determined by the search engine so that the error approximates to zero, (i.e., e(rₒ, rₙ)=0). For this to work, in practice, the adjusting function is Q(q, r). In particular embodiments, the calculation of ranking errors e(rₒ, rₙ) may be made in offline training

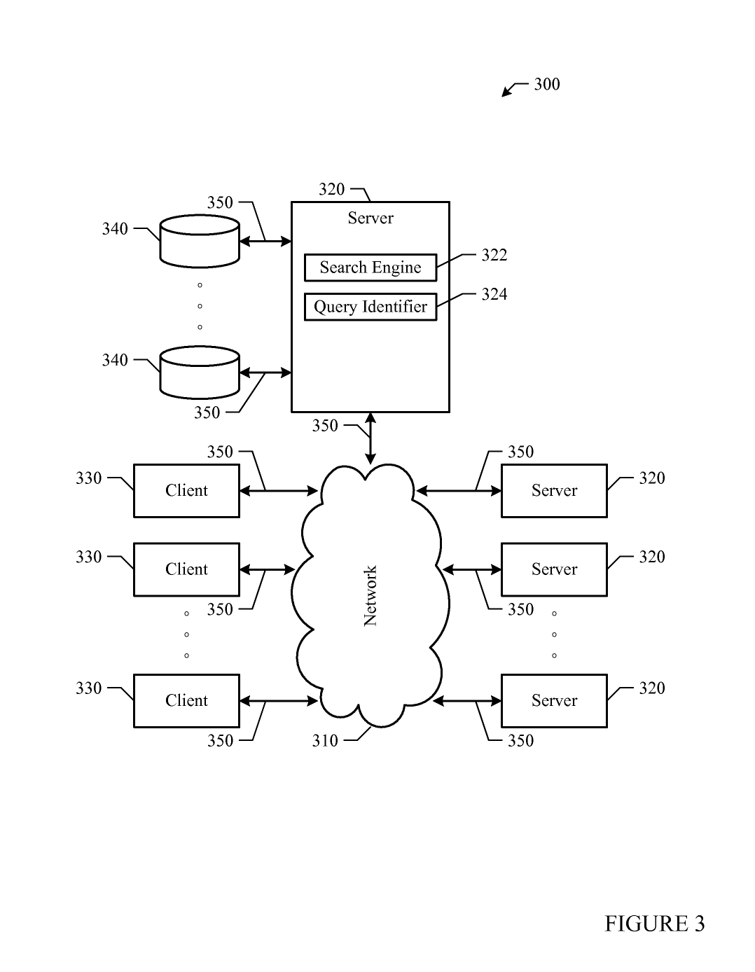

Particular embodiments may be implemented in a network environment. FIG. 3 illustrates an example network environment 300. Network environment 300 includes a network 310 coupling one or more servers 320 and one or more clients 330 to each other. In particular embodiments, network 310 is an intranet, an extranet, a virtual private network (VPN), a local area network (LAN), a wireless LAN (WLAN), a wide area network (WAN), a metropolitan area network (MAN), a communications network, a satellite network, a portion of the Internet, or another network 310 or a combination of two or more such networks 310. The present disclosure contemplates any suitable network 310.

One or more links 350 couple servers 320 or clients 330 to network 310. In particular embodiments, one or more links 350 each includes one or more wired, wireless, or optical links 350. In particular embodiments, one or more links 350 each includes an intranet, an extranet, a VPN, a LAN, a WLAN, a WAN, a MAN, a communications network, a satellite network, a portion of the Internet, or another link 350 or a combination of two or more such links 350. The present disclosure contemplates any suitable links 350 coupling servers 320 and clients 330 to network 310.

In particular embodiments, each server 320 may be a unitary server or may be a distributed server spanning multiple computers or multiple datacenters. Servers 320 may be of various types, such as, for example and without limitation, web server, news server, mail server, message server, advertising server, file server, application server, exchange server, database server, or proxy server. In particular embodiments, each server 320 may include hardware, software, or embedded logic components or a combination of two or more such components for carrying out the appropriate functionalities implemented or supported by server 320. For example, a web server is generally capable of hosting websites containing web pages or particular elements of web pages. More specifically, a web server may host HTML files or other file types, or may dynamically create or constitute files upon a request, and communicate them to clients 330 in response to HTTP or other requests from clients 330. A mail server is generally capable of providing electronic mail services to various clients 330. A database server is generally capable of providing an interface for managing data stored in one or more data stores.

In particular embodiments, each client 330 may be an electronic device including hardware, software, or embedded logic components or a combination of two or more such components and capable of carrying out the appropriate functionalities implemented or supported by client 330. For example and without limitation, a client 330 may be a desktop computer system, a notebook computer system, a netbook computer system, a handheld electronic device, or a mobile telephone. A client 330 may enable an network user at client 330 to access network 310. A client 330 may have a web browser, such as Microsoft Internet Explorer or Mozilla Firefox, and may have one or more add-ons, plug-ins, or other extensions, such as Google Toolbar or Yahoo Toolbar. A client 330 may enable its user to communicate with other users at other clients 330. The present disclosure contemplates any suitable clients 330.

In particular embodiments, one or more data storages 340 may be communicatively linked to one or more severs 320 via one or more links 350. In particular embodiments, data storages 340 may be used to store various types of information. In particular embodiments, the information stored in data storages 340 may be organized according to specific data structures. Particular embodiments may provide interfaces that enable servers 320 or clients 330 to manage (e.g., retrieve, modify, add, or delete) the information stored in data storage 340.

In particular embodiments, a server 320 may include a search engine 322. Search engine 322 may include hardware, software, or embedded logic components or a combination of two or more such components for carrying out the appropriate functionalities implemented or supported by search engine 322. For example and without limitation, search engine 322 may implement one or more search algorithms that may be used to identify network resources in response to the search queries received at search engine 322, one or more ranking algorithms that may be used to rank the identified network resources, one or more summarization algorithms that may be used to summarize the identified network resources, and so on. The ranking algorithms implemented by search engine 322 may be trained using the set of the training data constructed from pairs of search query and clicked URL.

In particular embodiments, a server 320 may also include a query identifier 324 that identifies whether a search query received at search engine 322 is a year-qualified query. Query identifier 324 may include hardware, software, or embedded logic components or a combination of two or more such components for carrying out the appropriate functionalities that it implements or supports.

Particular embodiments may be implemented as hardware, software, or a combination of hardware and software. For example and without limitation, one or more computer systems may execute particular logic or software to perform one or more steps of one or more processes described or illustrated herein. One or more of the computer systems may be unitary or distributed, spanning multiple computer systems or multiple datacenters, where appropriate. The present disclosure contemplates any suitable computer system. In particular embodiments, performing one or more steps of one or more processes described or illustrated herein need not necessarily be limited to one or more particular geographic locations and need not necessarily have temporal limitations. As an example and not by way of limitation, one or more computer systems may carry out their functions in “real time,” “offline,” in “batch mode,” otherwise, or in a suitable combination of the foregoing, where appropriate. One or more of the computer systems may carry out one or more portions of their functions at different times, at different locations, using different processing, where appropriate. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more computer-readable storage media may store or otherwise embody software implementing particular embodiments. A computer-readable medium may be any medium capable of carrying, communicating, containing, holding, maintaining, propagating, retaining, storing, transmitting, transporting, or otherwise embodying software, where appropriate. A computer-readable medium may be a biological, chemical, electronic, electromagnetic, infrared, magnetic, optical, quantum, or other suitable medium or a combination of two or more such media, where appropriate. A computer-readable medium may include one or more nanometer-scale components or otherwise embody nanometer-scale design or fabrication. Example computer-readable storage media include, but are not limited to, compact discs (CDs), field-programmable gate arrays (FPGAs), floppy disks, floptical disks, hard disks, holographic storage devices, integrated circuits (ICs) (such as application-specific integrated circuits (ASICs)), magnetic tape, caches, programmable logic devices (PLDs), random-access memory (RAM) devices, read-only memory (ROM) devices, semiconductor memory devices, and other suitable computer-readable storage media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

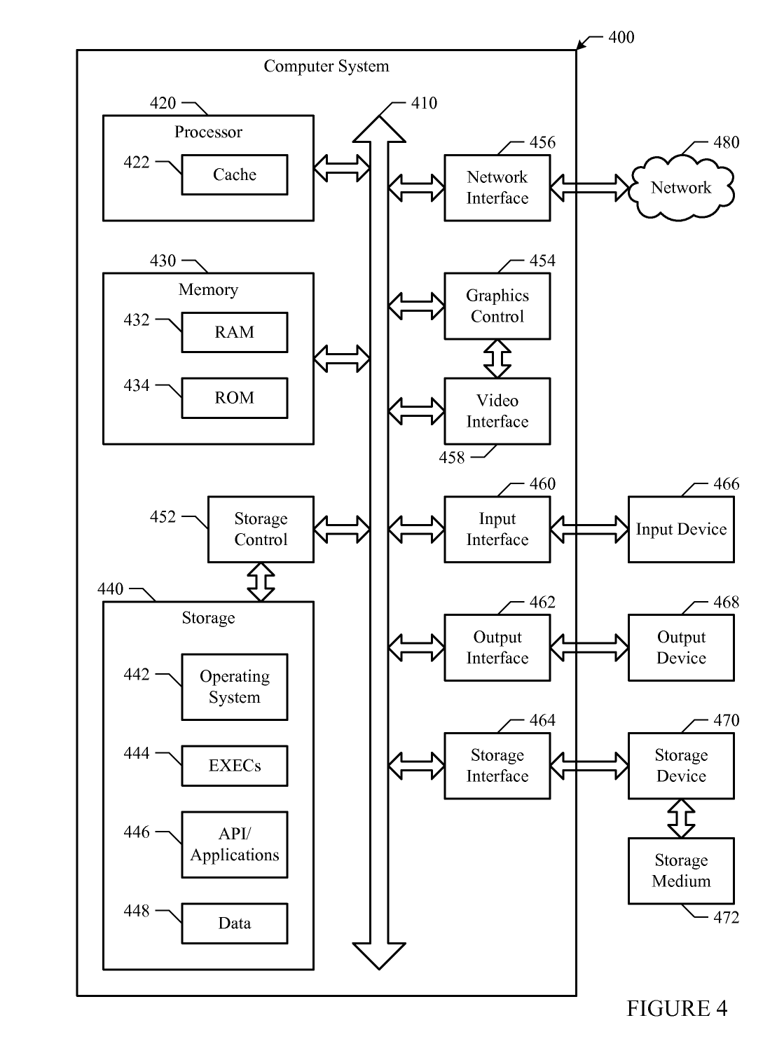

For example, FIG. 4 illustrates an example computer system 400 suitable for implementing one or more portions of particular embodiments. Although the present disclosure describes and illustrates a particular computer system 400 having particular components in a particular configuration, the present disclosure contemplates any suitable computer system having any suitable components in any suitable configuration. Moreover, computer system 400 may have take any suitable physical form, such as for example one or more integrated circuit (ICs), one or more printed circuit boards (PCBs), one or more handheld or other devices (such as mobile telephones or PDAs), one or more personal computers, or one or more super computers.

System bus 410 couples subsystems of computer system 400 to each other. Herein, reference to a bus encompasses one or more digital signal lines serving a common function. The present disclosure contemplates any suitable system bus 410 including any suitable bus structures (such as one or more memory buses, one or more peripheral buses, one or more a local buses, or a combination of the foregoing) having any suitable bus architectures. Example bus architectures include, but are not limited to, Industry Standard Architecture (ISA) bus, Enhanced ISA (EISA) bus, Micro Channel Architecture (MCA) bus, Video Electronics Standards Association local (VLB) bus, Peripheral Component Interconnect (PCI) bus, PCI-Express bus (PCI-X), and Accelerated Graphics Port (AGP) bus.

Computer system 400 includes one or more processors 420 (or central processing units (CPUs)). A processor 420 may contain a cache 422 for temporary local storage of instructions, data, or computer addresses. Processors 420 are coupled to one or more storage devices, including memory 430. Memory 430 may include random access memory (RAM) 432 and read-only memory (ROM) 434. Data and instructions may transfer bidirectionally between processors 420 and RAM 432. Data and instructions may transfer unidirectionally to processors 420 from ROM 434. RAM 432 and ROM 434 may include any suitable computer-readable storage media.

Computer system 400 includes fixed storage 440 coupled bi-directionally to processors 420. Fixed storage 440 may be coupled to processors 420 via storage control unit 452. Fixed storage 440 may provide additional data storage capacity and may include any suitable computer-readable storage media. Fixed storage 440 may store an operating system (OS) 442, one or more executables 444, one or more applications or programs 446, data 448, and the like. Fixed storage 440 is typically a secondary storage medium (such as a hard disk) that is slower than primary storage. In appropriate cases, the information stored by fixed storage 440 may be incorporated as virtual memory into memory 430.

Processors 420 may be coupled to a variety of interfaces, such as, for example, graphics control 454, video interface 458, input interface 460, output interface 462, and storage interface 464, which in turn may be respectively coupled to appropriate devices. Example input or output devices include, but are not limited to, video displays, track balls, mice, keyboards, microphones, touch-sensitive displays, transducer card readers, magnetic or paper tape readers, tablets, styli, voice or handwriting recognizers, biometrics readers, or computer systems. Network interface 456 may couple processors 420 to another computer system or to network 480. With network interface 456, processors 420 may receive or send information from or to network 480 in the course of performing steps of particular embodiments. Particular embodiments may execute solely on processors 420. Particular embodiments may execute on processors 420 and on one or more remote processors operating together.

In a network environment, where computer system 400 is connected to network 480, computer system 400 may communicate with other devices connected to network 480. Computer system 400 may communicate with network 480 via network interface 456. For example, computer system 400 may receive information (such as a request or a response from another device) from network 480 in the form of one or more incoming packets at network interface 456 and memory 430 may store the incoming packets for subsequent processing. Computer system 400 may send information (such as a request or a response to another device) to network 480 in the form of one or more outgoing packets from network interface 456, which memory 430 may store prior to being sent. Processors 420 may access an incoming or outgoing packet in memory 430 to process it, according to particular needs.

Computer system 400 may have one or more input devices 466 (which may include a keypad, keyboard, mouse, stylus, etc.), one or more output devices 468 (which may include one or more displays, one or more speakers, one or more printers, etc.), one or more storage devices 470, and one or more storage medium 472. An input device 466 may be external or internal to computer system 400. An output device 468 may be external or internal to computer system 400. A storage device 470 may be external or internal to computer system 400. A storage medium 472 may be external or internal to computer system 400.

Particular embodiments involve one or more computer-storage products that include one or more computer-readable storage media that embody software for performing one or more steps of one or more processes described or illustrated herein. In particular embodiments, one or more portions of the media, the software, or both may be designed and manufactured specifically to perform one or more steps of one or more processes described or illustrated herein. In addition or as an alternative, in particular embodiments, one or more portions of the media, the software, or both may be generally available without design or manufacture specific to processes described or illustrated herein. Example computer-readable storage media include, but are not limited to, CDs (such as CD-ROMs), FPGAs, floppy disks, floptical disks, hard disks, holographic storage devices, ICs (such as ASICs), magnetic tape, caches, PLDs, RAM devices, ROM devices, semiconductor memory devices, and other suitable computer-readable storage media. In particular embodiments, software may be machine code which a compiler may generate or one or more files containing higher-level code which a computer may execute using an interpreter.

As an example and not by way of limitation, memory 430 may include one or more computer-readable storage media embodying software and computer system 400 may provide particular functionality described or illustrated herein as a result of processors 420 executing the software. Memory 430 may store and processors 420 may execute the software. Memory 430 may read the software from the computer-readable storage media in mass storage device 430 embodying the software or from one or more other sources via network interface 456. When executing the software, processors 420 may perform one or more steps of one or more processes described or illustrated herein, which may include defining one or more data structures for storage in memory 430 and modifying one or more of the data structures as directed by one or more portions the software, according to particular needs. In addition or as an alternative, computer system 400 may provide particular functionality described or illustrated herein as a result of logic hardwired or otherwise embodied in a circuit, which may operate in place of or together with software to perform one or more steps of one or more processes described or illustrated herein. The present disclosure encompasses any suitable combination of hardware and software, according to particular needs.

Although the present disclosure describes or illustrates particular operations as occurring in a particular order, the present disclosure contemplates any suitable operations occurring in any suitable order. Moreover, the present disclosure contemplates any suitable operations being repeated one or more times in any suitable order. Although the present disclosure describes or illustrates particular operations as occurring in sequence, the present disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method, comprising:
accessing, by one or more computer systems, a search query received at a search engine;
identifying, by the one or more computer systems, a plurality of network resources for the search query;
calculating, by the one or more computer systems, a ranking score for each of the network resources;
determining, by the one or more computer systems, whether the search query is year-qualified; and
if the search query is year-qualified, then adjusting, by the one or more computer systems, the ranking scores of selected ones of the network resources based on a difference between the ranking score of an oldest one of the network resources and the ranking score of a newest one of the network resources and a confidence score representing a likelihood that the search query is year-qualified.

2. The method recited in claim 1, wherein determining whether the search query is year-qualified comprises:
parsing the search query; and
if a four-digit year is included in the search query, then identifying the search query as year-qualified.

3. The method recited in claim 1, further comprising:
extracting, by the one or more computer systems, a plurality of search queries from one or more search-engine logs, each of the search queries comprising a four-digit year;
removing, by the one or more computer systems, the four-digit year from each of the search queries; and
forming, by the one or more computer systems, a year-qualified query dictionary comprising the search queries without the four-digit years.

4. The method recited in claim 3, wherein determining whether the search query is year-qualified comprises:
comparing the search query with the search queries included in the year-qualified query dictionary; and
if the search query matches one of the search queries included in the year-qualified query dictionary, then identifying the search query as year-qualified.

5. The method recited in claim 1, further comprising:
determining, by the one or more computer systems, a timestamp for each of the network resources that comprises at least a year associated with the network resource; and
identifying, by the one or more computer systems, the newest one of the network resources and the oldest one of the network resources based on the timestamps of the network resources.

6. The method recited in claim 5, wherein each of the selected ones of the network resources has a timestamp year that is the same as a timestamp year of the newest one of the network resources.

7. The method recited in claim 1, wherein if the search query is year-qualified, then adjusting the ranking scores of the selected ones of the network resources only when the newest one of the network resources is ranked lower than the oldest one of the network resources based on their ranking scores.

8. The method recited in claim 1, wherein the confidence score partially controls an amount of the difference between the ranking score of the oldest one of the network resources and the ranking score of the newest one of the network resources applied to the ranking scores of the selected ones of the network resources.

9. A system, comprising:
a memory comprising instructions executable by one or more processors; and
one or more processors coupled to the memory and operable to execute the instructions, the one or more processors being operable when executing the instructions to:
access a search query received at a search engine;
identify a plurality of network resources for the search query;
calculate a ranking score for each of the network resources;
determine whether the search query is year-qualified; and
if the search query is year-qualified, then adjust the ranking scores of selected ones of the network resources based on a difference between the ranking score of an oldest one of the network resources and the ranking score of a newest one of the network resources and a confidence score representing a likelihood that the search query is year-qualified.

10. The system recited in claim 9, wherein to determine whether the search query is year-qualified comprises:
parse the search query; and
if a four-digit year is included in the search query, then identify the search query as year-qualified.

11. The system recited in claim 9, wherein the one or more processors are further operable when executing the instructions to:
extract a plurality of search queries from one or more search-engine logs, each of the search queries comprising a four-digit year;
remove the four-digit year from each of the search queries; and
form a year-qualified query dictionary comprising the search queries without the four-digit years.

12. The system recited in claim 11, wherein to determine whether the search query is year-qualified comprises:
compare the search query with the search queries included in the year-qualified query dictionary; and
if the search query matches one of the search queries included in the year-qualified query dictionary, then identify the search query as year-qualified.

13. The system recited in claim 9, wherein the one or more processors are further operable when executing the instructions to:
determine a timestamp for each of the network resources that comprises at least a year associated with the network resource; and
identify the newest one of the network resources and the oldest one of the network resources based on the timestamps of the network resources.

14. The system recited in claim 13, wherein each of the selected ones of the network resources has a timestamp year that is the same as a timestamp year of the newest one of the network resources.

15. The system recited in claim 9, wherein if the search query is year-qualified, then adjust the ranking scores of the selected ones of the network resources only when the newest one of the network resources is ranked lower than the oldest one of the network resources based on their ranking scores.

16. The system recited in claim 9, wherein the confidence score partially controls an amount of the difference between the ranking score of the oldest one of the network resources and the ranking score of the newest one of the network resources applied to the ranking scores of the selected ones of the network resources.

17. One or more computer-readable storage media embodying software operable when executed by one or more computer systems to:
access a search query received at a search engine;
identify a plurality of network resources for the search query;
calculate a ranking score for each of the network resources;
determine whether the search query is year-qualified; and
if the search query is year-qualified, then adjust the ranking scores of selected ones of the network resources based on a difference between the ranking score of an oldest one of the network resources and the ranking score of a newest one of the network resources and a confidence score representing a likelihood that the search query is year-qualified.

18. The media recited in claim 17, wherein to determine whether the search query is year-qualified comprises:
parse the search query; and
if a four-digit year is included in the search query, then identify the search query as year-qualified.

19. The media recited in claim 17, wherein the software is further operable when executed by the one or more computer systems to:
extract a plurality of search queries from one or more search-engine logs, each of the search queries comprising a four-digit year;
remove the four-digit year from each of the search queries; and
form a year-qualified query dictionary comprising the search queries without the four-digit years.

20. The media recited in claim 19, wherein to determine whether the search query is year-qualified comprises:
compare the search query with the search queries included in the year-qualified query dictionary; and
if the search query matches one of the search queries included in the year-qualified query dictionary, then identify the search query as year-qualified.

21. The media recited in claim 17, wherein the software is further operable when executed by the one or more computer systems to:
determine a timestamp for each of the network resources that comprises at least a year associated with the network resource; and
identify the newest one of the network resources and the oldest one of the network resources based on the timestamps of the network resources.

22. The media recited in claim 21, wherein each of the selected ones of the network resources has a timestamp year that is the same as a timestamp year of the newest one of the network resources.

23. The media recited in claim 17, wherein if the search query is year-qualified, then adjust the ranking scores of the selected ones of the network resources only when the newest one of the network resources is ranked lower than the oldest one of the network resources based on their ranking scores.

24. The media recited in claim 17, wherein the confidence score partially controls an amount of the difference between the ranking score of the oldest one of the network resources and the ranking score of the newest one of the network resources applied to the ranking scores of the selected ones of the network resources.
